(19) United States
(12) Patent Application Publication
(10) Pub. No.: US 2005/0216540 A1
(43) Pub. Date: Sep. 29, 2005

(54) Novel CORDIC circuit

(76) Inventors: Kuei-Ann Wen, HsinChu (TW); Chia-Sheng Peng, HsinChu (TW); Yuan-Shin Chuang, HsinChu (TW)

Correspondence Address: TRANSPACIFIC LAW GROUP, 617 NORTH DELAWARE STREET, SAN MATEO, CA, 94401, US

(21) Appl. No.: 10/811,450

(22) Filed: Mar. 25, 2004

(51) Int. Cl. G06F 15/00

(52) U.S. Cl. 708/200

(57) ABSTRACT

The CORDIC circuit of this invention comprises a buffer memory to record a plurality or a plurality of group of coordinate values; a phase selector to determine a rotation direction according to values recorded in said buffer memory; a rotation calculator to rotate an input coordinate for a predetermined angle and to calculate resulting coordinate value after such rotation; a rotation counter to count number of rotation being made to said input coordinate; and an angle accumulator to accumulate total rotation angle being made to said input coordinate according to value recorded by said rotation counter. The CORDIC circuit of this invention may further comprise a bit selector to shift bits of said input coordinate.

### FIELD OF THE INVENTION

The present invention relates to a novel CORDIC circuit, especially to a simplified CORDIC circuit. The present invention provides a simplified structure for the CORDIC circuit to reduce gate count of the CORDIC circuit.

### BACKGROUND OF THE INVENTION

Among all kinds of signal processing circuits, the CORDIC (coordinate rotation digital computer) circuit is a very useful tool to rotate the positive real number of the coordinate (rectangular coordinate or polar coordinate) representing a sampled signal. The CORDIC calculation is often used in the integration of digital signals. For example, when a CORDIC vector rotation processor receives a digital signal, it may conduct CORDIC processing of the digital signal by referring to the rotation angle of a reference signal, to generate a shifting signal. After such a processing, the sampling phase or sampling frequency of the signal processor may be modified, such that quality of digital signal processing may be improved.

The CORDIC may also be used in other data processing, such as to calculate the angle of an input vector.

When a CORDIC is used to calculate the angle of an input vector, the calculation may be expressed by:

$$( \begin{matrix}{x}_{( i + 1 )} \\ {y}_{( i + 1 )}\end{matrix} ) = ( \begin{matrix}1 & - {μ}_{i} {2}^{i - 1} \\ {μ}_{i} {2}^{i - 1} & 1\end{matrix} ) ( \begin{matrix}{x}_{( i )} \\ y ( i )\end{matrix} ) \qquad ( 1 )$$

wherein x₍ᵢ₎, y₍ᵢ₎ represent coordinate value before rotation, x₍ᵢ₊₁₎, y₍ᵢ₊₁₎ represent coordinate value after the i+1th rotation, i is 0 or positive integral, μᵢ represents angel of rotation, μᵢ=sign[x₍ᵢ₎*y₍ᵢ₎]. Thereby, result of the rotation shall make y₍ᵢ₊₁₎=0.

FIG. 3 illustrates the circuit diagram of a conventional digital coordinate converter. As shown in this figure, in such a circuit, a plurality of multiplier is needed. Due to the fact that the circuit of the multiplier is comparatively complicate, the use of a plurality of multiplier will make the whole circuit complicated in design and large in size, rendering the result of higher manufacture cost and lower operational speed.

In addition, the sign operation as described above involves the operation of complex numbers. Components used in the operation of complex numbers will further increase the size of the circuit, while precision of such calculation is limited. In the conventional art it is possible to prepare a look-up-table to replace the complicated circuit. However, the cost of the look-up-table is the memory space needed in recording the table. Using a look-up-table does not solve the problem of high manufacture cost and low operational speed.

It is thus necessary to provide a novel CORDIC circuit to simplify the CORDIC operation, to enhance the operational speed and to save the manufacture cost.

It is also necessary to provide a CORDIC circuit that does not need a multiplier.

It is also necessary to provide a CORDIC circuit with higher precisions.

### OBJECTIVES OF THE INVENTION

The objective of this invention is to provide a novel CORDIC circuit to simplify the CORDIC operation, to enhance the operational speed and to save the manufacture cost.

Another objective of this invention is to provide a CORDIC circuit that does not need a multiplier.

Another objective of this invention is to provide a CORDIC circuit with higher precisions.

Another objective of this invention is to provide a CORDIC circuit that is able to conduct CORDIC operation even when the amplitude of a sampled signal is extremely small.

### SUMMARY OF THE INVENTION

According to this invention, the CORDIC circuit comprises a buffer memory to record a plurality or a plurality of group of coordinate values; a phase selector to determine a rotation direction according to values recorded in said buffer memory; a rotation calculator to rotate an input coordinate for a predetermined angle and to calculate resulting coordinate value after such rotation; a rotation counter to count number of rotation being made to said input coordinate; and an angle accumulator to accumulate total rotation angle being made to said input coordinate according to value recorded by said rotation counter. The CORDIC circuit of this invention may further comprise a bit selector to shift bits of said input coordinate.

The above and other objectives and advantages of this invention may be clearly understood from the detailed description by referring to the following drawings.

### BRIEF DESCRIPTION OF THE DRAWINGS

FIG. 1 illustrates the system diagram of the CORDIC circuit of this invention.

FIG. 2 shows the flowchart of calculation of the CORDIC circuit of this invention.

FIG. 3 illustrates the circuit diagram of a conventional digital coordinate converter.

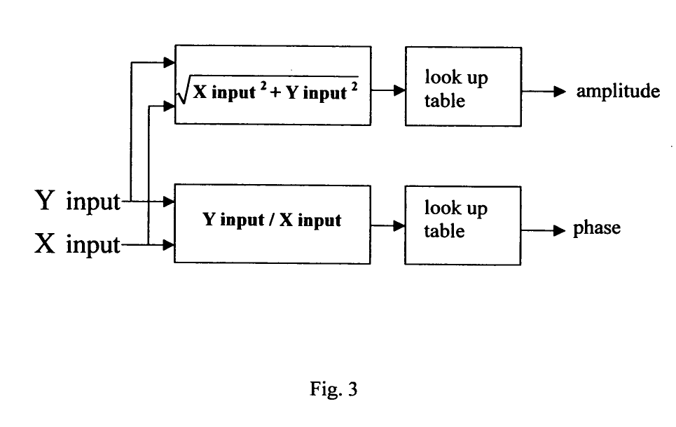

### DETAILED DESCRIPTION OF THE INVENTION

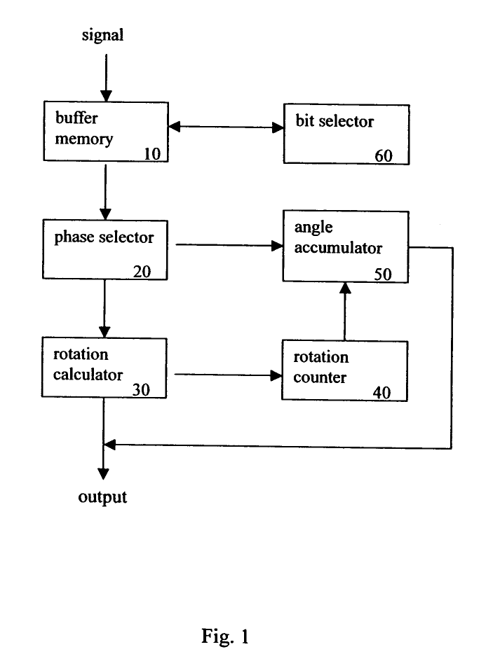

FIG. 1 illustrates the system diagram of the CORDIC circuit of this invention. As shown in this figure, the CORDIC circuit of this invention comprises a buffer memory 10 to record a plurality or a plurality of group of coordinate values; a phase selector 20 to determine a rotation direction according to values recorded in said buffer memory; a rotation calculator 30 to rotate an input coordinate for a predetermined angle and to calculate resulting coordinate value after such rotation; a rotation counter 40 to count number of rotation being made to said input coordinate; and an angle accumulator 50 to accumulate total rotation angle being made to said input coordinate according to value recorded by said rotation counter. The CORDIC circuit of this invention may further comprise a bit selector 60 to shift bits of said input coordinate.

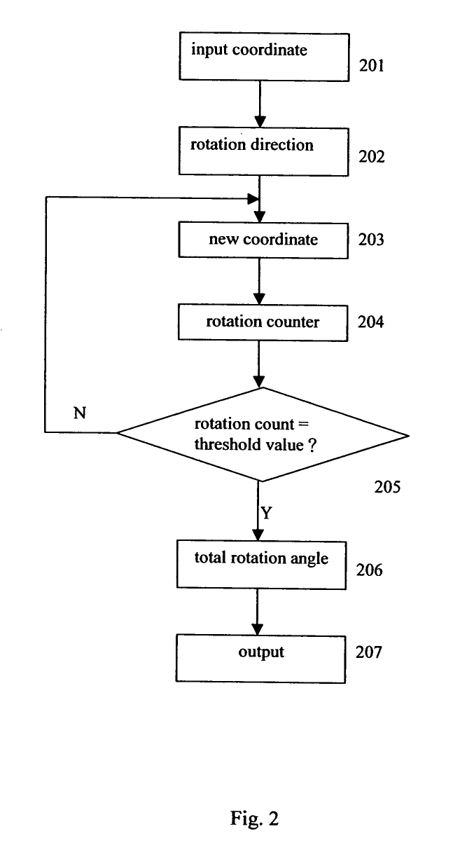

The calculation of the CORDIC circuit of this invention will be described in the following. FIG. 2 shows the flowchart of calculation of the CORDIC circuit of this invention. As shown in this figure, when conducting a CORDIC operation, at 201 a coordinate is input and is stored in the coordinate buffer memory 10. At 202 the phase selector 20 determines a rotation direction according to the value of the input coordinate. When making such a determination, the phase selector 20 may determine a direction according to value of the x, y coordinate to be positive or negative. Of course, other methods to determine the relative direction of a signal point and a standard vector may also be used in this invention. At 203 the rotation calculator 30 rotates the input coordinate for a predetermined angle to generate a new coordinate. In this invention, the rotation of a coordinate includes the rotation of an angle of

$$\pm \frac{π}{4 \times {2}^{n}}$$

radians, wherein n represents counts of rotation made to the input coordinate. Direction of the rotation is the positive- or negative-value as determined by the phase selector 20.

In the practical application, the rotation calculator 30 calculates the resulting coordinate of the rotation according to the following equations:
xᵢ₊₁=xᵢ−μᵢyᵢ2⁻¹
yᵢ₊₁=yᵢ+μᵢxᵢ2⁻¹ (2)
wherein x₀, y₀ represent initial input coordinate, xᵢ₊₁, yᵢ₊₁ represent coordinate after the i+1th rotation, μᵢ=sign(xᵢ*yᵢ), i represents number of rotation.

In addition to the above-said method, other rotation processing at predetermined angles may also be used in this invention, as long as complicated circuits such as multiplier are not used in the CORDIC circuit.

At 204 number of rotation processing is recorded in the rotation counter 40 and the current coordinate is recorded in the coordinate buffer memory 10. Then at 205 number of rotation is compared with a threshold value to see whether a predetermined number of rotation has been conducted. If not, the process returns to step 202 and steps 202 to 204 are repeated. Otherwise, at 206 the angle accumulator 50 accumulates the total rotation angle. Calculation of the total rotation angle may be conducted according to the following equation:
R=ΣμᵢZᵢ (3)

In this equation, R represents the total rotation angle; Z is phase value as recorded in advance. In the accumulation the angle, direction and number of the rotation are taken and accumulated.

In another embodiment of this invention, the relative angle of the rotated coordinate is compared with a base vector. When the difference between the relative angle and the base vector is smaller than a threshold value, the rotation is stopped.

At 207 the total rotation angle and the resulted coordinate are output. In the output data, the x coordinate represents the amplitude of the signal.

By using the above-described circuit, a CORDIC circuit without a multiplier is realized. The rotation angle may be obtained after the iteration and the resulted coordinate and length of the vector are obtained directly after the calculation.

The invented CORDIC circuit may not only rotate an input coordinate to approximate the X axle. It is able to rotate a vector to any angle.

The CORDIC circuit of this invention may further comprise a bit selector 60, to shift the bits of an input coordinate or a resulted coordinate.

According to the present invention, in the operation of a CORDIC circuit, error in operation will become obvious, when amplitude of the input signal is too small. This is because yᵢ2⁻ⁱ and xᵢ2⁻ⁱ decrease tremendously when i becomes greater. To solve such a problem it is necessary to provide more bits to represent values of xᵢ and yᵢ. This, however, makes the circuit complicated and increases the manufacture cost of the CORDIC circuit.

The bit selector 60 of this invention shifts the input coordinate to the direction of the higher bits, according to the most significant bit (MSB), so that the value of the coordinate is enlarged. Such a processing may include shifting the MSB of x₀ or y₀, whichever is higher, to the bit following the positive- or negative-symbol, followed by shifting the other for the same number of bits. Of course, other methods of bit-shifting may be used in this invention, as long as the x₀, y₀ coordinate may be enlarged.

After such bit-shifting, the input coordinate is recorded in the buffer memory 10 for further use. After the coordinate is processed by the CORDIC circuit of this invention, the resulted coordinate is shifted in a reversed way by the shift selector 60, so that the true value of the resulted coordinate may be obtained.

In order to prove the effects of this invention, a CORDIC circuit of this invention including a shift selector is prepared. All input coordinates are expressed by 10 bits and angle of the vector is expressed by 12 bits. The experiment shows that error of the CORDIC calculation is limited to less than 5 bits, while in the conventional art, error is always above 900 bits. The effect of this invention is obvious.

Table I shows the maximum error of this invention against the known art.

TABLE I

| | Maximum | |
|---|---|---|
| | Error (Conventional) | Maximum Error (This invention) |
| EXT_bit = 4 | 968 | 3 |
| EXT_bit = 3 | 968 | 3 |
| EXT_bit = 2 | 971 | 4 |

As the present invention has been shown and described with reference to preferred embodiments thereof, those skilled in the art will recognize that the above and other changes may be made therein without departing form the spirit and scope of the invention.

1. A coordinate rotation digital computer (CORDIC) circuit, comprising:
a buffer memory to record a plurality or a plurality of group of coordinate values;
a phase selector to determine a rotation direction according to values recorded in said buffer memory;
a rotation calculator to rotate an input coordinate for a predetermined angle and to calculate resulting coordinate value after such rotation;
a rotation counter to count number of rotation being made to said input coordinate; and
an angle accumulator to accumulate total rotation angle being made to said input coordinate according to value recorded by said rotation counter.

2. The CORDIC circuit according to claim 1, further comprising a bit selector to shift bits of said input coordinate.

3. The CORDIC circuit according to claim 1 or 2, wherein said rotation calculator rotates a coordinate at the angle of
$$\pm \frac{π}{4 \times {2}^{n}} ,$$
wherein n represents number of rotation and direction thereof is determined by said phase selector.

4. The CORDIC circuit according claim 1 or 2, wherein said phase selector determines direction of rotation according to the positive- or negative-value of said input coordinate.

5. The CORDIC circuit according to claim 1 or 2, wherein said rotation calculator calculates resulted coordinate value of a rotation according to the following equations:
xᵢ₊₁=xᵢ−μᵢyᵢ2⁻¹
yᵢ₊₁=yᵢ+μᵢxᵢ2⁻¹
wherein x₀, y₀ represent input coordinate, xᵢ₊₁, yᵢ₊₁ represent coordinate after the i+1th rotation, μᵢ=sign(xᵢ*yᵢ), i represents number of rotation.

6. Method of using a CORDIC circuit to calculate angle of a vector, comprising the following steps:
a. obtaining an input coordinate;
b. determining a rotation direction according to said input coordinate;
c. rotating said input coordinate for a predetermined angle to said determined rotation direction to obtain a new coordinate;
d. recording said rotation;
e. comparing number of rotation being recorded with a threshold value; if said number of rotation is smaller than said threshold value, steps b to e are repeated; otherwise
f. accumulate total rotation angle; and
g. output said total rotation angle and said new coordinate.

7. Method of using a CORDIC circuit to calculate angle of a vector, comprising:
a. a obtaining an input coordinate;
b. determining a rotation direction according to said input coordinate;
c. rotating said input coordinate for a predetermined angle to said determined rotation direction to obtain a new coordinate;
d. recording said rotation;
e. accumulating total rotation angle;
f. comparing said total rotation angle with a threshold value;
g. if difference between said total rotation angle and aid threshold value is greater than a predetermined value, repeating steps (b) to (f); otherwise
h. outputting said total rotation angle and said new coordinate.

8. The method according to claim 6 or 7, further comprising a step of shifting bits of said input coordinate.

9. The method according to claim 6 or 7, wherein said rotation of a predetermined angle comprising rotating said input coordinate at the angle of
$$\pm \frac{π}{4 \times {2}^{n}} ,$$
wherein n represents number of rotation and direction thereof is determined by said phase selector.

10. The method according claim 6 or 7, wherein determination of rotation direction is made according to the positive- or negative-value of said input coordinate.

11. The method according to claim 6 or 7, wherein said rotation of a predetermined angle comprising calculation of coordinate after rotation according to the following equations:
xᵢ₊₁=xᵢ−μᵢyᵢ2⁻¹
yᵢ₊₁=yᵢ+μᵢxᵢ2⁻¹
wherein x₀, y₀ represent input coordinate, xᵢ₊₁, yᵢ₊₁ represent coordinate after the i+1th rotation, μᵢ=sign(xᵢ*yᵢ), i represents number of rotation.
